(19) United States
(12) Patent Application Publication
(10) Pub. No.: US 2011/0020521 A1
(43) Pub. Date: Jan. 27, 2011

(54) Method For Manufacturing Jam Using Watermelon

(75) Inventors: Ki-ok Park, Gimje-si (KR); Jeong-bin An, Gimje-si (KR); So-jin An, Gimje-si (KR)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignees: Sunnongwon Agricultural Management Cooperation, Gimje-si (KR); Ki-ok Park, Gimje-si (KR)

(21) Appl. No.: 12/711,239

(22) Filed: Feb. 23, 2010

(30) Foreign Application Priority Data
Jul. 21, 2009 (KR) 10-2009-0066318

(51) Int. Cl. A23L 1/064

(52) U.S. Cl. 426/578

(57) ABSTRACT

Provided is a method for manufacturing jam using watermelon, and more particularly, with respect to storability, processibility, manufacturing economy, productivity; use of additives, etc., a new method for manufacturing jam, which is required to manufacture uniform quality watermelon jam which maintains a suitable quality by quantifying the parameters, is constant and stable, and satisfies the palates of average consumers.

The present invention includes a method, including: washing the surface of a watermelon and collecting the seeds, separating 100 parts by weight of the edible portion from the rind portion of the watermelon, grinding it into particles, placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight; placing 100 parts by weight of the watermelon flesh separated from the step in a pot to heat it at about 105° C. to about 115° C. for about 30 min while stirring; adding about 10 to about 20 parts by weight of an extract from Chinese quince and about 15 to about 20 parts by weight of refined sugar into the boiling watermelon flesh to additionally heat the mixture at about 105° C. to about 115° C. while stirring it for about 30 min such that it does not stick to the bottom of the pot; and reducing the heat to about 90° C. to about 105° C. and then stirring the mixture for about 20 min to complete the watermelon jam such that the concentration of the jam becomes about 50 to about 60%.

### CROSS-REFERENCE TO RELATED APPLICATIONS

This application claims priority under 35 U.S.C. §119 to Korean Patent Application No. 10-2009-0066318, filed on Jul. 21, 2009, the disclosure of which is incorporated herein by reference in its entirety.

### TECHNICAL FIELD

The present disclosure relates to a method for manufacturing jam using watermelon, and more particularly, to a new method for manufacturing jam, with respect to storability, processibility, manufacturing economy, productivity, use of additives, etc., which is required to manufacture uniform quality watermelon jam which maintains a suitable quality by quantifying the parameters, is constant and stable, and satisfies the palates of average consumers.

### BACKGROUND

Conventional methods for manufacturing jam of fruits, such as apple, orange, peach, apricot, etc., have been widely known and general jam manufacturing methods may be easily applied. However, jam of watermelon, which is a typical fruit in summer, is unusual and general methods for manufacturing jam are not common.

Some wild types of watermelon according to regions are widely consumed in beverage, feed, medicine, etc. However, cultivated types are eaten as it is mostly in summertime. Watermelon punch (“Subak hwachae” in Korean) is consumed as a dessert, watermelon for seed is cultivated in China, and oil squeezed from the seed of watermelon is used as an edible oil in Africa. Watermelon contains moisture content of about 91% as a main ingredient and lots of saccharide. It is known that saccharide is composed mainly of fructose and glucose, quenches thirst in sultry season, and is helpful for recovering from fatigue. Because the fruit contains various minerals and vitamins A and. C in addition to saccharide, it has a high nutritional value. Because the seed of watermelon, in particular, contains a lot of nutritional ingredients such as protein, fat, and vitamin B group as well as saccharide, it has been reported that the intake of the ingredients is beneficial to the human body.

Because watermelon contains a special amino acid known as citrulline, an intermediate metabolite in the urea cycle, to help in vivo urea synthesis, diuretic effects increased by watermelon are helpful for those who are suffering from kidney dysfunction. It has been known that the juice from the white part of fresh watermelon has medicinal effects on fever, sweat, feeling of oppression in the chest, and thirst due to hot weathers in summer and therapeutic effects for nephritis, sore throat, tonsillitis, cystitis, hypertension, edema, and stomatitis.

Methods of manufacturing watermelon jam based on these values of watermelon have been known. For example, a method for cooling the watermelon flesh as an important part for the manufacture of jam including: using a less sweet part which is a boundary between the rind and the flesh, boiling down sugar and lemon juice, and adding starch is known. Korean Patent Publication No. 10-2005-0118249 discloses “METHOD OF MAKING WATERMELON JAM”.

The disclosure relates to a method of manufacturing watermelon jam including freezing followed by thawing and low temperature aging, and more particularly to a method of manufacturing jam, including freezing the flesh of watermelon at −10° C. or lower, followed by thawing and aging at low temperatures of 2° C. to 4° C. for about 6 to about 7 days.

Although methods of manufacturing jam using watermelon have been known in relation to food manufacturing as described above, there still remain many parameters to improve upon for the method of manufacturing satisfactory quality watermelon jam. With respect to, for example, storability, processibility, manufacturing economy, productivity, use of additives, etc., a new method for manufacturing watermelon jam is required to manufacture uniform quality watermelon jam which maintains a suitable quality by quantifying the parameters, is constant and stable, and satisfies the palates of average consumers.

### SUMMARY

Accordingly, with respect to storability, processibility, manufacturing economy, productivity, use of additives, etc., in the manufacture of the watermelon jam, the present disclosure provides a new method of manufacturing watermelon jam, which is required to manufacture uniform quality watermelon jam which maintains a suitable quality by quantifying the parameters, is constant and stable, and satisfies the palates of average consumers.

In order to solve the problems and achieve the objects, a method for manufacturing watermelon jam, includes:

washing the surface of a watermelon and collecting the seeds, separating 100 parts by weight of the edible portion from the rind portion of the watermelon, grinding it into particles, placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight;

placing 100 parts by weight of the watermelon flesh separated from the step in a pot to heat it at about 105° C. to about 115° C. for about 30 min while stirring;

adding about 10 to about 20 parts by weight of an extract from Chinese quince and about 15 to about 20 parts by weight of refined sugar into the boiling watermelon flesh to additionally heat the mixture at about 105° C. to about 115° C. while stirring it for about 30 min such that it does not stick to the bottom of the pot; and reducing the heat to about 90° C. to about 105° C. and then stirring the mixture for about 20 min to complete the watermelon jam such that the concentration of the jam becomes about 50 to about 60%.

The extract from Chinese quince is obtained by a method including: washing Chinese quinces and removing moisture, dicing the Chinese quinces into a thickness of about 0.5 mm to separate the seeds, mixing 50 parts by weight of the flesh in which seeds are removed with 50 parts by weight of refined sugar and putting the mixture in a sealed container; storing the mixture in a cool place for about 3 months, and using a mesh for filtration to obtain the extract.

According to another aspect of the present invention, a method for manufacturing watermelon jam, includes: washing the surface of a watermelon and collecting the seeds, separating 100 parts by weight of the edible portion from the rind portion of the watermelon, grinding it into particles, placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight;

placing 100 parts by weight of the watermelon flesh separated from the step in a pot to heat it at about 105° C. to about 115° C. for about 30 min while stirring;

adding about 10 to about 20 parts by weight of an extract from Japanese apricot and about 15 to about 20 parts by weight of refined sugar into the boiling watermelon flesh to additionally heat the mixture at about 105° C. to about 115° C. while stirring it for about 30 min such that it does not stick to the bottom of the pot; and reducing the heat to about 90° C. to about 105° C. and then stirring the mixture for about 20 min to complete the watermelon jam such that the concentration of the jam becomes about 50 to about 60%.

The extract from Japanese apricot is obtained by a method including: washing Japanese apricots, mixing 50 parts by weight of the dehydrated Japanese apricots with 50 parts by weight of refined sugar and putting the mixture in a sealed container, storing the mixture in a cool place for about 3 months, and using a mesh for filtration to obtain the extract.

### DETAILED DESCRIPTION OF EMBODIMENTS

Hereinafter, preferred embodiments of the present invention will be described in detail.

In describing the present invention, detailed description about related known functions or structures will be omitted if the detailed description may unnecessarily obscure the substance of the present invention.

A method for manufacturing jam according to preferred embodiments of the present invention may be, provided in the following manner.

### First Embodiment

A watermelon jam may be manufactured by washing the surface of a watermelon and collecting the seeds, separating 100 parts by weight of the edible portion from the rind portion of the watermelon, grinding it into particles, placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight; placing 100 parts by weight of the watermelon flesh separated from the step in a pot to heat it at about 105° C. to about 115° C. for about 30 min while stirring; adding about 10 to about 20 parts by weight of an extract from Chinese quince and about 15 to about 20 parts by weight of refined sugar into the boiling watermelon flesh to additionally heat the mixture at about 105° C. to about 115° C. while stirring it for about 30 min such that it does not stick to the bottom of the pot; and reducing the heat to about 90° C. to about 105° C. and then stirring the mixture for about 20 min to complete the watermelon jam such that the concentration of the jam becomes about 50 to about 60%.

The extract from Chinese quince may be preferably obtained by a method including: washing. Chinese quinces and removing moisture, dicing the Chinese quinces into a thickness of about 0.5 mm to separate the seeds; mixing 50 parts by weight of the flesh in which seeds are removed with 50 parts by weight of refined sugar and putting the mixture in a sealed container, storing the mixture in a cool place for about 3 months, and using a mesh for filtration to obtain the extract.

In the Chinese quince extract, the peculiar taste and flavor of the Chinese quince is meager before three months of fermentation while the taste and flavor is not different in three months of fermentation. Thus, it was known that the three month period was best suitable for fermentation of watermelon jam.

A watermelon jam of the present invention may be also prepared.

### Second Embodiment

A watermelon jam may be prepared by washing the surface of a watermelon and collecting the seeds, separating 100 parts by weight of the edible portion from the rind portion of the watermelon, grinding it into particles, placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight; placing 100 parts by weight of the watermelon flesh separated from the step in a pot to heat it at about 105° C. to about 115° C. for about 30 min while stirring; adding about 10 to about 20 parts by weight of an extract from Japanese apricot and about 15 to about 20 parts by weight of refined sugar into the boiling watermelon flesh to additionally heat the mixture at about 105° C. to about 115° C. while stirring it for about 30 min such that it does not stick to the bottom of the pot; and reducing the heat to about 90° C. to about 105° C. and then stirring the mixture for about 20 min to complete the watermelon jam such that the concentration of the jam becomes about 50 to about 60%.

The extract from Japanese apricot may be preferably obtained by a method including: washing Japanese apricots mixing 50 parts by weight of the dehydrated Japanese apricots with 50 parts by weight of refined sugar and putting the mixture in a sealed container, storing the mixture in a cool place for about 3 months and using a mesh for filtration to obtain the extract.

In the Japanese apricot extract, the peculiar taste and flavor of the Japanese apricot is meager before three months of fermentation while the taste and flavor is not different in three months of fermentation. Thus, it was known that the three month period was best suitable for fermentation of watermelon jam.

The analysis results of watermelon jam prepared according to the present invention are summarized in the following <Table 1>.

TABLE 1

| Item | Result | Item | Result |
|---|---|---|---|
| Calories | 207.18/100 g | Saturated fat. | 0.0 g/100 g |
| Carbohydrate | 51.01 g/100 g | Trans fat | 0.0 g/100 g |
| Moisture | 45.51% (± 0.09) | Cholesterol | 0.0/100 g |
| Ash | 1.00% (± 0.15) | Sugars | 55.25 g/100 g |
| Crude protein | 2.38 g/100 g (± 0.00) | Crude fiber | 1.82% (± 0.01) |
| Crude fat | 0.1% (± 0.00) | | |

It was confirmed that the color of the jam was a peculiar color of watermelon and its flavor contained a sufficient amount of watermelon flavor even though the tastes and flavors are different each other according to Chinese quince and Japanese apricot extracts. It was also confirmed that the taste of jam is soften by natural sugars, such as glucose and fructose, and amino acid ingredients which watermelon Contains and the jam contained the peculiar taste and flavor of watermelon which may not be obtained from other fruits.

A jam may be prepared by a method for manufacturing watermelon jam according to the present invention, using the flesh of watermelon with which is generally considered impossible to manufacture a jam without a pectin ingredient. The taste and flavor of the jam may be enriched by amino acids and lycopene which are contained in watermelon ingredients, and the jam may be widely used for the improvement and enhancement of the health by appropriate combination with watermelon ingredients.

The present invention may mass-produce watermelon jam which is excellent in storability because it does not spoil and may be stored for a long time by heating the watermelon flesh to manufacture the watermelon jam without subjecting to freezing and thawing of the watermelon flesh. The present invention also provides an excellent processibility by boiling and heating the jam after the manufacture of watermelon flesh and quantifying new additives, and may contribute to the commercialization of watermelon jam by adding Chinese quince and Japanese apricot extracts which are known to be healthful to the human body and providing a watermelon jam which is constant in taste and flavor and easy to eat.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for manufacturing watermelon jam, comprising:
washing the surface of a watermelon and collecting the seeds, separating 100 parts by weight of the edible portion from the rind portion of the watermelon, grinding it into particles, placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight;
placing 100 parts by weight of the watermelon flesh separated from the step in a pot to heat it at about 105° C. to about 115 for about 30 min while stirring;
adding about 10 to about 20 parts by weight of an extract from Chinese quince and about 15 to about 20 parts by weight of refined sugar into the boiling watermelon flesh to additionally heat the mixture at about 105° C. to about 115° C. while stirring it for about 30 min such that it does not stick to the bottom of the pot; and
reducing the heat to about 90° C. to about 105° C. and then stirring the mixture for about 20 min to complete the watermelon jam such that the concentration of the jam becomes about 50 to about 60%.

2. The method of claim 1, wherein the extract from Chinese quince is obtained by washing Chinese quinces and removing moisture, dicing the Chinese quinces into a thickness of about 0.5 mm to separate the seeds, mixing 50 parts by weight of the flesh in which seeds are removed with 50 parts by weight of refined sugar and putting the mixture in a sealed container, storing the mixture in a cool place for about 3 months, and using a mesh for filtration to obtain the extract.

3. A method for manufacturing watermelon jam, comprising:
washing the surface of a watermelon and collecting the seeds, separating 100 parts by weight of the edible portion from the rind portion of the watermelon, grinding it into particles, placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight;
placing 100 parts by weight of the watermelon flesh separated from the step in a pot to heat it at about 105° C. to about 115° C. for about 30 min while stirring;
adding about 10 to about 20 parts by weight of an extract from Japanese apricot and about 15 to about 20 parts by weight of refined sugar into the boiling watermelon flesh to additionally heat the mixture at about 105° C. to about 115° C. while stirring it for about 30 min such that it does not stick to the bottom of the pot; and
reducing the heat to about 90° C. to about 105° C. and then stirring the mixture for about 20 min to complete the watermelon jam such that the concentration of the jam becomes about 50 to about 60%.

4. The method of claim 3, wherein the extract from Japanese apricot is obtained by washing Japanese apricots mixing 50 parts by weight of the dehydrated Japanese apricots with 50 parts by weight of refined sugar and putting the mixture in a sealed container, storing the mixture in a cool place for about 3 months and using a mesh for filtration to obtain the extract.
